(19) United States
(12) Patent Application Publication
(10) Pub. No.: US 2012/0001742 A1
(43) Pub. Date: Jan. 5, 2012

(54) OBSTACLE SEARCH SYSTEM

(75) Inventors: Satoshi NOZOE, Chiryu-city (JP); Tsutomu Matsuno, Okazaki-city (JP)

(73) Assignee: DENSO CORPORATION, Kariya-city (JP)

(21) Appl. No.: 13/089,647

(22) Filed: Apr. 19, 2011

(30) Foreign Application Priority Data
Jul. 5, 2010 (JP) 2010-153196

(51) Int. Cl. B60Q 1/00; G06F 17/00

(52) U.S. Cl. 340/435; 701/49

(57) ABSTRACT

An obstacle search system includes an operation unit for accepting a direction input operation by an occupant of a vehicle and a displacement sensor for detecting displacement of the operation unit according to the direction input operation, for moving a detection enabled area of an obstacle detector. Based on the movement of the detection enabled area of the obstacle detector, the occupant is supported to correctly recognize a positional relationship between the vehicle and the obstacle and to effectively reduce the number of unnecessary obstacle detections.

### CROSS REFERENCE TO RELATED APPLICATION

The present application is based on and claims the benefit of priority of Japanese Patent Application No. 2010-153196, filed on Jul. 5, 2010, the disclosure of which is incorporated herein by reference.

### FIELD OF THE INVENTION

The present invention generally relates to an obstacle search system that searches around a vehicle for an obstacle and presents search results as information of an obstacle for an occupant of the vehicle.

### BACKGROUND INFORMATION

For recognizing an around-the-vehicle condition at a time of parking, the driver of the vehicle typically uses his/her eyes as well as mirrors. However, the recognition of the around-the-vehicle condition as well as the recognition of a size and a position of a currently-driving vehicle only by using the eyes and mirrors have a certain limitation due to a dead angle and/or a recognition error of the eyes. As a result, the recognition of the around-the-vehicle in the above-described manner may lead to bumping against the obstacle around the vehicle, or may lead to reservation of an unnecessarily large space between the obstacle and the vehicle, thereby damaging an effective driving.

Therefore, an automatic obstacle position sensing technique has been proposed for notifying the driver of the vehicle about the obstacle when the obstacle is detected in a predetermined detection area of a sensor, as a solution of the above-described problem. For example, a patent document 1 discloses a technique that forms a detection area in an oval shape at a front and a side of the vehicle by using an ultrasonic sensor and notifies the user of the obstacle detected in the detection area.

[a patent document 1] Japanese Patent Laid-Open No. 2009-234295

However, in an actual driving situation, an area to be monitored by the driver should change according to the driving conditions and/or driver's mental condition. In other words, if the sensor detection area is fixed as disclosed in the patent document 1, that may lead to an inconvenience of the driver disabling detection of the obstacle that needs to be or should have been detected.

More specifically, though the technique in the patent document 1 may work appropriately for a situation in which an unnoticed obstacle in a predetermined detection area in a dead angle is detected and notified to the driver only passively, the technique may not work appropriately for a situation in which an active determination of a distance to an already-noticed obstacle is desired by the driver.

In other words, the technique in the patent document 1 is problematic when the driver actively searches an around-the-vehicle space for an obstacle and actively learns a sense of distance based on the results of the obstacle. search. That is, the conventional technique does not provide an appropriate support for the driver when the driver is trying to correctly grasp a positional relationship between the obstacle and an own vehicle.

In addition, according to the technique in the patent document 1, the obstacle already being noticed by the driver is detected in vain and notified to the driver due to the fixed detection area of the detection apparatus, thereby unnecessarily bothering the driver.

### SUMMARY OF THE INVENTION

In view of the above and other problems, the present invention provides an obstacle search system for appropriately supporting an occupant of a vehicle to correctly grasp a positional relationship between a subject vehicle and an obstacle and for reducing an unnecessary detection of the obstacle.

In an aspect of the present disclosure, the obstacle search system for use in a vehicle includes: an obstacle detector for detecting a position of an obstacle in a measurement range, with a measurement range move section for moving the measurement range of the obstacle detector included therein; an information presenter for presenting information of the position of the detected obstacle; an operation device having an operation unit for accepting a direction input operation from an occupant of the vehicle and a displacement detector for detecting displacement of the operation unit by the direction input operation; and a measurement range controller for controlling the measurement range move section to move the measurement range according to the displacement detected by the displacement detector. Therefore, the occupant of the vehicle can actively search for an obstacle by moving the measurement range toward a user-intended direction and can detect the obstacle in the moved measurement range. As a result, the occupant can learn a sense of distance between the subject vehicle and the obstacle based on the detection results, and the system can support the occupant to correctly grasp the positional relationship of the obstacle relative to the vehicle.

Further, as the measurement range can be moved toward the user-intended direction for detecting the obstacle, an already-noticed obstacle that is thus not-necessarily required to be detected can be excluded from the measurement range of the obstacle detector. That is, unnecessary detection of the obstacle is reduced.

Further, in another aspect of the obstacle search system, the obstacle detector identifies a direction and a distance of the obstacle relative to the vehicle as the position of the detected obstacle, and the information presenter presents the information of the detected obstacle based on the direction and the distance of the detected obstacle. Therefore, the occupant can learn the sense of distance to the obstacle based on the direction and the distance of the obstacle relative to the vehicle presented by the information presenter, thereby allowing the occupant to more correctly and in detail grasp the sense of distance and the like.

In yet another aspect of the obstacle search system, the information presenter presents the information of the position of the detected obstacle through haptic sensation of the occupant of the vehicle. Therefore, the occupant of the vehicle can have the information of the position of the obstacle presented while he/she confirms the obstacle by eyes or through mirrors. Further, the occupant can learn the sense of the distance toward the obstacle while confirming the obstacle by eyes and through mirrors, thereby allowing the vehicle to be safely driven when accurately learning the sense of distance toward the obstacle.

For the purpose of presenting the information of position of the obstacle through haptic sensation, the information presenter and the operation unit are preferably disposed on a vehicle equipment that is operated by a hand of the occupant, and the occupant is enabled to operate the operation unit while the occupant is operating the equipment.

In this manner, the occupant can operate the equipment and can move the measurement range of the detector at the same time, and can further have the presentation of the position information of the obstacle detected by the detector. That is, the usability of the system is improved.

Further, in addition to the above, preferably, the obstacle detector identifies a direction and a distance of the detected obstacle relative to the vehicle as the position of the detected obstacle, and the information presenter presents the direction plus distance information of the detected obstacle by applying a reactive operation force to the operation unit based on the direction and the distance of the detected obstacle.

In this manner, the information presenter presents the information according to the direction/distance of the obstacle by applying the reactive operation force to the operation unit, thereby allowing the occupant to know the direction and distance of the detected obstacle based on the reactive operation force while moving the measurement range of the detector by the direction input operation. As a result, the occupant of the own vehicle is supported and enabled to accurately grasping and establishing the sense of positions of the obstacle and the vehicle, thereby allowing recognition of the vehicle size of the vehicle, by repeating a series of a detection enabled area movement step and a detected information grasping step, based on the sense of distance from those steps. As a result, the occupant of the own vehicle can accurately recognize the relationship between the own vehicle and the obstacle.

Further, if the reactive operation force is used, the following operation scheme can be used.

For example, the information presenter decreases an application cycle of the reactive operation force in proportion to closeness of the detected obstacle to the vehicle. In this manner, the decrease of the application cycle of the reactive operation force to the operation unit according to the closeness of the obstacle to the vehicle can practically present the distance of the obstacle to the vehicle, based on a sense of urgency caused in the occupant from the shorter interval of the application cycle of the reactive operation force.

The information presenter may increase an amount of the reactive operation force in proportion to closeness of the detected obstacle to the vehicle. In this manner, the increase of the the reactive operation force to the operation unit according to the closeness of the obstacle to the vehicle can practically present the distance of the obstacle to the vehicle, based on a sense of urgency caused in the occupant from the increased reactive operation force.

Further, the information presenter and the operation unit may be disposed on at least one of hand-operated vehicle equipments including a steering wheel, a steering switch, an operation device on a center console, and a shift knob.

Further, the information presenter may present the information of the position of the detected obstacle by providing mechanical stimulus to the occupant from an actuator that is capable of causing a physical displacement. Further, the measurement range controller includes a vehicle-related information acquisition unit for acquiring vehicle-related information including at least one of driving information of the vehicle and surrounding environment information of the vehicle, and an amount of the movement of the measurement range by the measurement range move section according to the displacement detected by the displacement detector is corrected based on the vehicle-related information from the vehicle-related information acquisition unit. Therefore, the movement of the measurement range by the measurement range move section can be controlled according to the driving information of the vehicle and the surrounding environment information. That is, for example, the amount of the movement may be increased when the vehicle speed is greater, or the amount of the movement may be decreased when the visibility of the vehicle environment decreases at night or due to bad weather, thereby controlling the amount of the movement suitably according to the condition of the vehicle and its environment.

Further, the obstacle detector may detect the obstacle in the measurement range by using one or more obstacle detection sensors.

Further, the operation unit may be displaceable in all directions or in fixed directions within a predetermined displacement range on an operation plane that is defined by two mutually-orthogonal axes along a lateral and longitudinal directions of the vehicle, and the displacement detector may detect an amount and a direction of the displacement of the operation unit due to the direction input operation by using a displacement sensor.

Further, in addition to the above, the operation unit may preferably be displaceable in all directions within the predetermined displacement range on the operation plane by utilizing a combination of two slide tables sliding along the lateral and longitudinal directions of the vehicle.

Further, the displacement of the operation unit may not be detected by the displacement detector as the direction input operation accepted by the operation unit if the operation unit is determined to be in a disturbed condition, and the operation unit may be determined to be in the disturbed condition during an operation of a steering wheel of the vehicle if the operation unit is disposed on the steering wheel.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of configuration of an obstacle search system in an embodiment of the present invention;

FIG. 2 is a conceptual illustration of an operation unit of a human machine interface (HMI) device in the embodiment of the present invention;

FIG. 3 is an illustration of configuration of the HMI device in the embodiment of the present invention;

FIG. 4 is an illustration of an installation position of the HMI device in the embodiment of the present invention;

FIG. 5 is an illustration of another installation position of the HMI device in the embodiment of the present invention;

FIG. 6 is an illustration of yet another installation position of the HMI device in the embodiment of the present invention;

FIG. 7 is an illustration of still yet another installation position of the HMI device in the embodiment of the present invention;

FIG. 8 is an illustration of still yet another installation position of the HMI device in the embodiment of the present invention; and

FIGS. 9A to 9C are illustrations of operation of the obstacle search system in the embodiment of the present invention.

### DETAILED DESCRIPTION

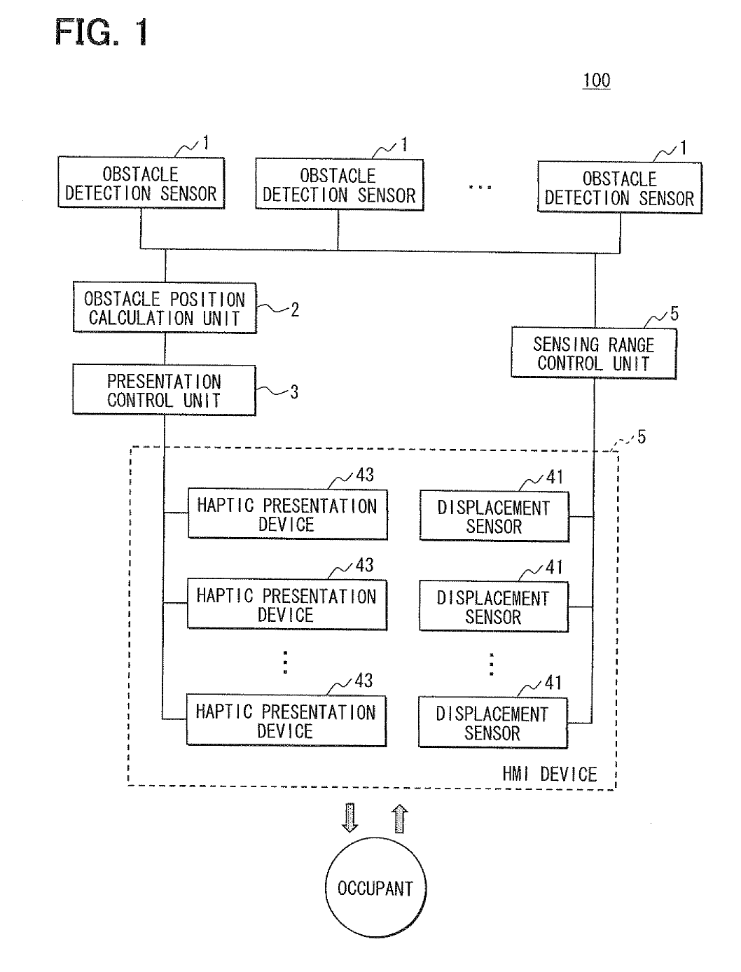

An embodiment of the present invention is explained with a drawing as follows. FIG. 1 is a block diagram of configuration of the obstacle search system 100 to which the present invention is applied. The obstacle search system 100 shown in FIG. 1 is installed in a vehicle, having an obstacle detection sensor 1, an obstacle position calculation unit 2, a presentation control unit 3, a human-machine interface (HMI) device 4 and a sensing range control unit 5 included therein. In addition, a vehicle carrying the obstacle search system 100 is called an own vehicle in the following.

The obstacle detection sensor 1 is carried by a vehicle, and it is a device detecting the obstacle in a set measurement range (a detection enabled area, hereinafter) around the own vehicle. As the obstacle detection sensor 1, a well-known range-finding sensor such as a supersonic wave sonar, a millimeter wave radar and a laser radar or an infrared ray sensor transmitting an incident wave and receiving a reflection wave reflected back from the obstacle can be used. In addition, as the obstacle detection sensor 1, imaging devices such as CCD cameras imaging the surrounding of the own vehicle may be used, or the range-finding sensor and the imaging device described above may be used in combination. Further, only one obstacle detection sensor 1 may be used for obstacle detection, or a multiplicity of obstacle detection sensors 1 may be used for covering a desired measurement range. In the present embodiment, use of only one range-finding sensor as the obstacle detection sensor 1 is explained.

In the following, the detection enabled area is explained. In the range-finding sensor, a measurement range, or the detection enabled area, can be changed by changing setting of the time to wait for a reflection wave of the incident wave after transmitting an incident wave. For example, a detection enabled area will become smaller and only a nearby obstacle can be detected if a waiting time for waiting for the reflection wave from the obstacle is shortened. On the other hand, a detection area will become wider and a far-off obstacle can be detected if a waiting time for waiting for the reflection wave from the obstacle is lengthened. Therefore, the obstacle detection sensor 1 is equivalent to a measurement range move section in claims.

In addition, the obstacle detection sensor 1 is installed for each of all directions in the present embodiment, such as a front direction, a rear direction, a left direction, a right direction, a diagonally front right direction, a diagonally rear right direction, a diagonally front left direction and a diagonally rear left direction, for example, for sending and receiving the waves for obstacle detection.

The obstacle position calculation unit 2 is a microcomputer having CPU, ROM, RAM, backup RAM and the like, and determines, by executing programs stored in the ROM, a direction and a distance to the obstacle relative to the own vehicle based on a sensor signal from the obstacle detection sensor 1, that is, based on a detection result of the obstacle detection sensor 1, and the direction of the obstacle for the own vehicle and a position such as the distance are identified by performing various control programs memorized by ROM. Therefore, the obstacle detection sensor 1 and the obstacle position calculation unit 2 are equivalent to an obstacle detector in claims.

More specifically, the obstacle position calculation unit 2 calculates the distance to an obstacle based on a gap between a timing of the transmission of the incident wave and the timing of the reception of the reflection wave of the incident wave, and the direction of the obstacle for the own vehicle is calculated by using a triangular surveying method from data of distance calculated by each sensor signal from plural supersonic wave sonars. In addition, the obstacle position calculation unit 2 may be configured to use other well-known methods to calculate the direction and the distance of the obstacle from the own vehicle.

In case that an imaging device is used as the obstacle detection sensor 1, the obstacle position calculation unit 2 may calculate the direction of the obstacle for the own vehicle by using a well-known image recognition processing based on a captured image. Further, the distance between the obstacle and the own vehicle may also be calculated based on the captured image when estimation or calculation of the distance to the own vehicle based on the captured image is feasible.

The presentation control unit 3, formed as a microcomputer having CPU, ROM, RAM, backup RAM and the like, performs control of a haptic presentation unit 43 of the HMI device 4 mentions later by performing various control programs memorized by ROM based on various information inputs from the obstacle position calculation unit 2.

The HMI device 4 includes an operation unit 41, a displacement sensor 42 and the haptic presentation unit 43. The HMI device 4 is installed on an equipment in the own vehicle that is manipulated by a hand of the vehicle occupant such as a driver, a navigator, and passengers, in a manner that allows a touch on the HMI device 4 by the vehicle occupant while he/she is manipulating the HMI device 4. The HMI device 4 is equivalent to the operation device in claims. The installation positions of the HMI device 4 are described in detail later in the specification.

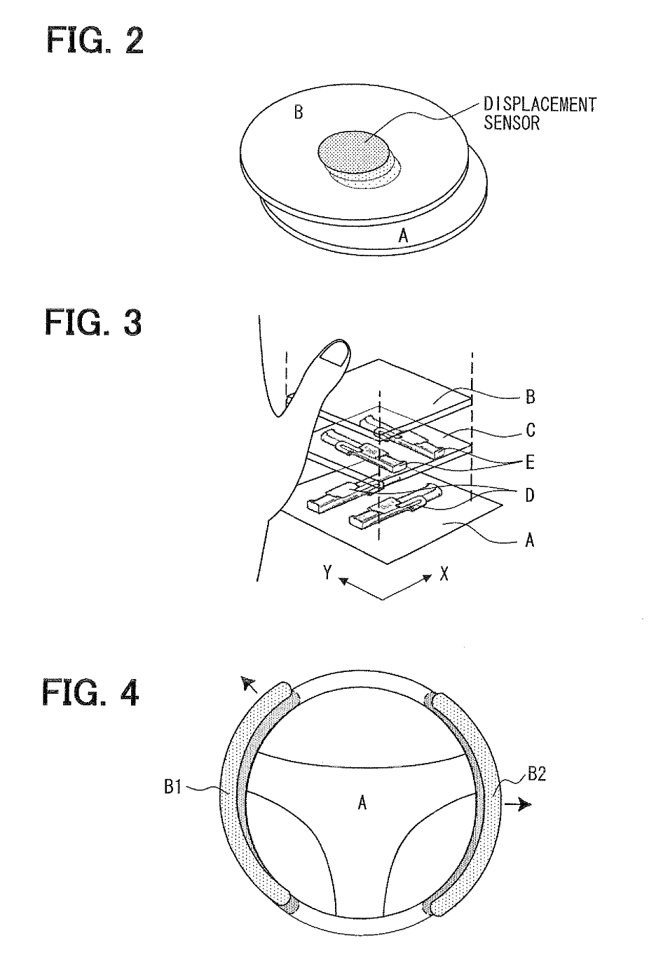

FIG. 2 is a conceptual illustration of the configuration of the HMI device 4, which is, more specifically, a operation unit 41 of the HMI device 4. As shown in FIG. 2, the operation unit 41 includes two parts, a fixed part A and a movable part B. The fixed part A is fixed on the equipage of the own vehicle as stated above. In the present embodiment, the fixed part A is fixed on a steering wheel of the own vehicle, for example. The movable part B is movable relative to the fixed part A. In other words, the movable part B can be displaced from an original position, and relative to the fixed part A.

More specifically, the movable part B is displaceable in all directions or in fixed directions within a predetermined range on an operation plane that is defined by two mutually-orthogonal axes along a lateral and longitudinal directions of the own vehicle, that is, a “front-rear” axis and a “right-left” axis. In the present embodiment, the front-rear axis, is assumed to be an axis that is aligned with an up-down direction of a plane of the steering wheel at a “straight” position (i.e., when the steering wheel is not in a steered position), to be serving as Y axis, and the right-left axis is assumed to be an axis that is aligned to a right to left direction of a plane of the steering wheel when the steering wheel is at the straight position, to be serving as X axis. In addition, the predetermined range of displacement in this case means a movable range that can be arbitrarily set.

In the present embodiment, a linear slider is installed between the fixed part A and the movable part B, as shown in FIG. 3. The liner slider is installed along the X axis to be slidable along the X axis, and is also installed along the Y axis to be slidable along the Y axis. In combination of those two slidable directions, the movable part B can be slidable in all directions. In the present embodiment, a small linear slider sliding along a guide on a table is, for example, used. The small linear slider is realized, for example, by using a a supersonic wave linear motor.

FIG. 3, schematically showing the HMI device 4, is explained in detail in the following. In addition, in FIG. 3, only a part of the fixed part A and a part of the movable part B are shown for the purpose of convenience. Between the fixed part A and the movable part B, in the present embodiment, a well-known linear slider D having a slide direction along the X axis and a well-known linear slider E having a slide direction along the Y axis direction having a slide direction along the X axis direction are provided as shown in FIG. 3.

More practically, two linear sliders D are installed on the surface of the fixed part A, upon which a plate C (an intermediate part C) having two linear sliders E are installed thereon is slidably installed. In other words, two linear sliders D and two linear sliders E form a lattice shape as shown in FIG. 3. The movable part B is installed on top of the two linear sliders E. In this case, a table of the linear slider D is fixed on the intermediate part C, and a table of the linear slider E is fixed on the movable part B.

By the above-mentioned configuration, the movable part B can be moved in a direction that is a combination of the slide direction of the linear slider D (in other words, Y axis direction) and the slide direction of the linear slider E (in other words, X axis direction) relative to the fixed part A. In other words, according to an external force from the operation of the occupant, the movable part B can be displaceable in all directions relative to the fixed part A based on the above-described configuration.

Further, the HMI device 4 includes the displacement sensor 42 as mentioned above. The displacement sensor 42 is a sensor detecting an amount of displacement of the movable part B, and information of the amount of detected displacement is sent to the sensing range control unit 5. The displacement sensor 42 is equivalent to the displacement detector in claims. In the present embodiment, one of two linear sliders D and one of two linear sliders E have the displacement sensor 42, and the amount of displacement of the linear sliders along each of the X axis direction and the Y axis direction (in other words, the amount of slide) shall be detected.

Further, the HMI device 4 detects a displacement direction of the movable part B based on a detection result of the displacement sensors 42 in respectively different detection directions. In other words, based on the amount of displacement of the linear slider along each of the X axis direction and the Y axis direction, the displacement direction of the movable part B is determined. In addition, based on both of the amount of displacement of the linear slider along the Y axis direction and the amount of displacement of the linear slider along the X axis direction, an actual displacement direction of the movable part B can be determined. Therefore, the HMI device 4 can detect a displacement direction and an amount of displacement of the movable part B in all directions of the steering wheel plane.

In addition, the displacement sensor 42 is a well-known displacement sensor detecting an amount of movement (i.e., an amount of displacement) of a detection object, and may be formed as a displacement sensor of non-contact type utilizing a light, a magnetic field, a sound wave or the like, or as a displacement sensor of contact type. In addition, the displacement sensor 42 may be configured to detect an amount of absolute displacement of the movable part B, or may be configured to detect an amount of relative displacement of the movable part B relative to the fixed part A. Furthermore, as long as detecting the amount of displacement of the movable part B, the displacement sensor 42 may be installed on the fixed part A, or may be installed on the movable part B.

Further, in the above-mentioned embodiment, the displacement sensor 42 is installed in each of the linear slider D and the linear slider E. However, only one displacement sensor 42 may be used, if the sensor 42 can detect both of the amount of displacement and the displacement direction of the movable part B.

Further, the HMI device 4 has the haptic presentation unit 43 as mentioned above. The haptic presentation unit 43 drives an actuator causing physical displacement according to instructions of the presentation control unit 3. By providing mechanical stimulation to through the present actuator to the occupant of the own vehicle, the information of the position of an obstacle identified by the obstacle position calculation unit 2 is presented. The presentation control unit 3 and the haptic presentation unit 43 are equivalent to an information presenter in claims. In the present embodiment, by employing the linear sliders D and E as an actuator, the movable part B is moved to a certain direction by a predetermined amount, thereby causing a resistance force against the operation of the movable part B and presenting the information of the position of the obstacle calculated by the obstacle position calculation unit 2.

Again, the movable part B can be moved in all directions of the steering wheel plane relative to the fixed part A, by combining the slidable direction of the linear slider D and the slidable direction of the linear slider E, as mentioned above.

The details of the processing of the presentation of the information of the position of the obstacle from the HMI device 4, which is performed under instructions of the presentation control unit 3, are explained in the following. First, the presentation control unit 3 acquires the information of the position of the obstacle calculated by the obstacle position calculation unit 2. Then, the presentation control unit 3 determines the slide amount of the linear slider D and linear slider E according to a direction and a distance of the obstacle calculated by the obstacle position calculation unit 2.

For example, the presentation control unit 3 makes the amount of displacement greater when the distance of the obstacle is closer, to generate a greater resistance force for the operation of the movable part B, for the purpose of providing a sense of urgency to the occupant. In addition, the presentation control unit 3 can apply the resistance force from the direction of the obstacle by changing/adjusting the slide amount of both of the linear sliders D and E, as the sliders D and E are disposed mutually orthogonally along the X and Y axes, corresponding to the front-rear and right-left of the own vehicle. That is, one of the sliders D and E slides along a front-rear direction of the own vehicle, and the other one slides along a right-left direction of the own vehicle.

More practically, the following example is shown. That is, when the direction of the obstacle is determined as a rear direction, that is, when the obstacle is positioned right behind the vehicle, by determining the slide amount of the linear slider D as 0 and determining the slide amount of the linear slide E as a certain amount toward an upper direction of the Y axis, the resistance force may be applied to the movable part B from a lower direction of the steering wheel plane. If the direction of the obstacle is the diagonally right rear direction of the own vehicle by 45 degrees, the slide amount of the slider D toward the left along the X axis direction and the slide amount of the slider E toward the upper side along the Y axis direction may be determined as the same amount to apply the resistance force from the diagonally right lower direction on the steering wheel plane to the movable part B.

In addition, though the distance of the obstacle calculated by the obstacle position calculation unit 2 is presented by adjusting the slide amount of the sliders D and E (i.e., the amount of resistance force against the operation of the movable part B) in the above-mentioned embodiment, other methods can be employed for achieving the same effects. That is, for example, by adjusting a period of back and forth movements of the sliders D and E (i.e., a frequency of resistance force against the operation of the movable part B), the distance to the obstacle calculated by the obstacle position calculation unit 2 may be presented. In this case, the period of the slider movement may be shortened when the obstacle is closer, for causing the resistance force more frequently, for the purpose of providing a sense of urgency to the occupant.

In addition, the above-described linear slider may be replaced with other devices, such as a slide table or the like, for realizing the haptic presentation unit 43. Further, as the haptic presentation unit 43, actuators such as a motor or a solenoid may be used to cause a reactive operation force to the movable part B.

For example, when vibration from a well-known motor or solenoid is used to present the information of the position of the obstacle, the haptic presentation unit 43 may have the well-known motor vibrator or solenoid vibrator in plural displacement directions of the movable part B, and the movable part B may be vibrated by using the vibrator in the desired presentation directions, to transmit the vibration to the hand of the occupant, providing a sense of direction of the obstacle as the information of the obstacle.

In addition, when two vibrators are positioned with a space interposed therebetween, the amount of vibration of the two vibrators may be adjusted and changed to provide a sense of direction to the occupant, for the purpose of positioning the direction of the obstacle controlled in between the directions of the two vibrators.

In addition, when the information of the distance of the obstacle is presented to the occupant, the amount of vibration may be controlled to be proportional to the closeness of the obstacle. That is, the amount of vibration of the vibrator may be increased when the distance of the obstacle is decreasing, or the cycle of vibration may be shortened when the distance of the obstacle is decreasing.

In addition, the displacement of the movable part B in all directions of the steering wheel plane may be limited to predetermined directions only. The predetermined directions may be selected from among the above-described all directions, as multiple directions or as only one direction on the steering wheel plane. Further, when the displacement direction of the movable part B is limited, the information of the direction of the obstacle by the haptic presentation unit 43 is also limited. That is, in that case, the direction of the obstacle can only be presented from the displacement direction of the moveable part B.

In addition, the HMI device 4 may be installed at a 10:10 position on the steering wheel, that is, a typical grasping position of the driver, or at other positions on the steering wheel, depending on the configuration.

Furthermore, in the HMI device 4, more than one movable parts may be provided. That is, for example, the movable part B may be provided as movable parts B1 and B2 as shown in FIG. 4, respectively for the operation by the right hand the left hand. The number of the movable parts may be more than three. When two or more movable parts are provided, each of the movable parts has a required number of displacement sensors for detecting displacement of that part, and each of the movable parts has a required number of the presentation units 43 to generate the reactive operation force.

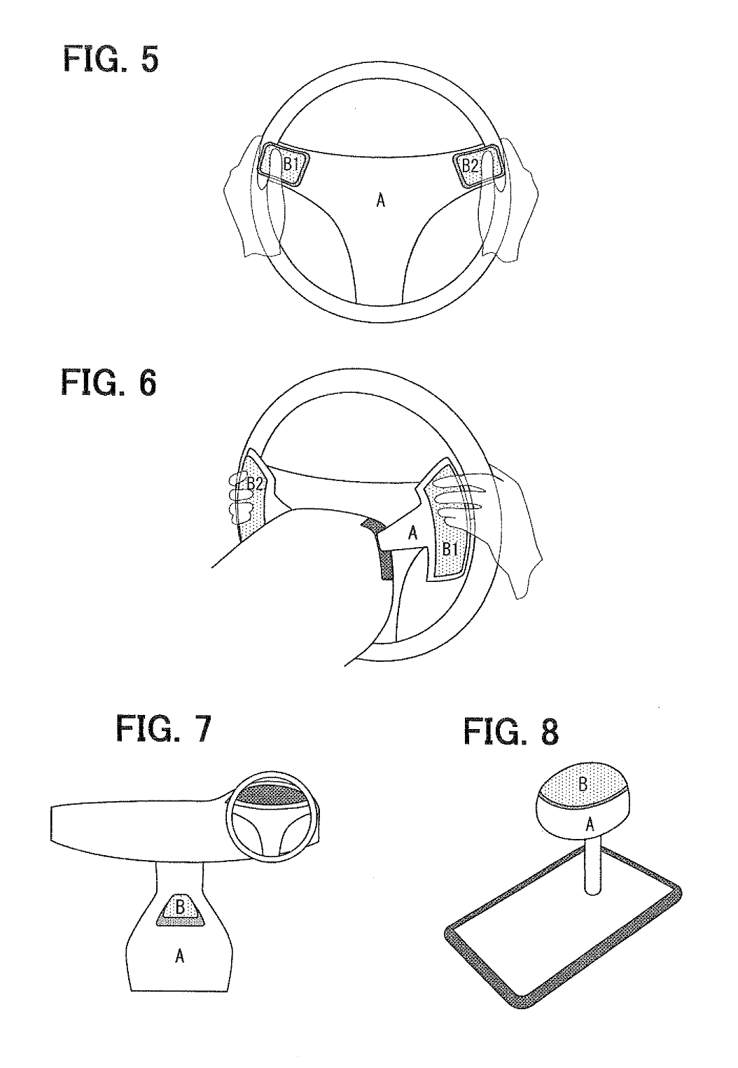

In the present embodiment, a steering wheel is shown as an example of an equipage of the own vehicle on which the HMI device 4 is installed. However, the HMI device 4 may be installed on any equipment that is operated by the hand of the occupant of the own vehicle. That is, the HMI device 4 may be installed, for example, on a steering switch which is on the front surface of the steering wheel (see FIG. 5), or on a back side steering switch installed on the back of the steering wheel (see FIG. 6), or on an operation device on the center console (see FIG. 7), or on a shift knob (see FIG. 8).

The sensing range control unit 5 in FIG. 1 is a microcomputer having CPU, ROM, RAM, backup RAM and the like, and performs control to move the detection enabled area of the obstacle detection sensor 1 by executing various control programs memorized by ROM based on various information inputs from the displacement sensor 42 of the HMI device 4.

More specifically, the sensing range control unit 5 moves the detection enabled area according to a displacement direction and an amount of displacement of the movable part B detected by the displacement sensor 42. Therefore, the sensing range control unit 5 is equivalent to the measurement range controller in claims. As described above, the slide direction of the linear slider D (i.e., X axis direction) corresponds to the right and left direction of the own vehicle and the slide direction of the linear slider E (i.e., Y axis direction) corresponds to the front and rear direction of the own vehicle, the displacement of the up and down direction of the movable part B is associated with the movement of the detection enabled area in the front and rear direction of the own vehicle, and the displacement of the right and left direction of the movable part B is associated with the movement of the detection enabled area in the right and left direction of the own vehicle.

For example, when the displacement direction of the movable part B is straight downward, for moving an overall detection enabled area, a detection enabled area of the obstacle detection sensor 1 for a rear direction of the own vehicle is increased in proportion to the amount of displacement of the movable part B detected by the displacement sensor 42 by changing a setting of the waiting time of the obstacle detection sensor 1 for the rear direction, and a detection enabled area of the obstacle detection sensor 1 for a front direction of the own vehicle is decreased in proportion to the amount of displacement of the movable part B detected by the displacement sensor 42 by also changing a setting of the waiting time of the obstacle detection sensor 1 for the front direction.

The amount of movement of the detection enabled area may be determined as proportional to the displacement amount of the movable part B, and the proportion value of the movement may be variably determined.

Further, the amount of movement of the detection enabled area, based on the displacement direction and displacement distance of the moveable part B detected by the displacement sensor 42, may be corrected according to a travel condition of the own vehicle, or according to information of vehicle environment around the own vehicle. In that case, the sensing range control unit 5 may acquire, for example, a vehicle speed of the own vehicle as the travel condition of the own vehicle detected by a speed sensor (not illustrated). As the information of vehicle environment, weather information and/or traffic information of the nearby roads may be acquired by a navigation system (not illustrated) from a VICS (registered trademark in Japan) information center, or time information regarding a day and a night may be acquired from a timing device (not illustrated). The sensing range control unit 5 is equivalent to a vehicle-related information acquisition unit in claims, and information of the travel condition of the own vehicle is equivalent to driving information in claims, and information of vehicle environment around the own vehicle is equivalent to environment information in claims.

The correction of the amount of the movement of the detection enabled area may be performed in the following manner according to the environment, for example. That is, when the speed of the own vehicle increases, or when the visibility of the vehicle environment decreases at night or due to bad weather, the sensing range control unit 5 may correct the amount of movement (movement, hereinafter) of the detection enabled area to be increased.

In the above, the movement of the detection enabled area by changing the setting of the waiting time of each of the obstacle detection sensors 1 is described. However, the detection enabled area may be moved in a different manner. That is, for example, when the obstacle detection by the obstacle position calculation unit 2 is configured to perform a certain processing for the obstacles that are detected as within a predetermined distance from the own vehicle by the obstacle detection sensors 1, the predetermined distance in the obstacle detection sensors 1 may be changed by the obstacle position calculation unit 2 for moving the detection enabled area.

Further, the detection enabled area may be moved by controlling a crop area in the image captured by the obstacle detection sensor 1 under control of the obstacle position calculation unit 2, when the obstacle detection sensor 1 is an imaging sensor and the obstacle detection is performed within the image from the imaging sensor by the obstacle position calculation unit 2. In this case, the obstacle position calculation unit 2 is equivalent to a measurement range move section in claims.

Furthermore, when the imaging sensor is used as the obstacle detection sensor 1 and an imaging direction and/or a focus distance of the imaging sensor is controllable by using a motor or the like, the movement of the detection enabled area may be performed by controlling the imaging direction and/or the focus distance of each of the obstacle detection sensor 1.

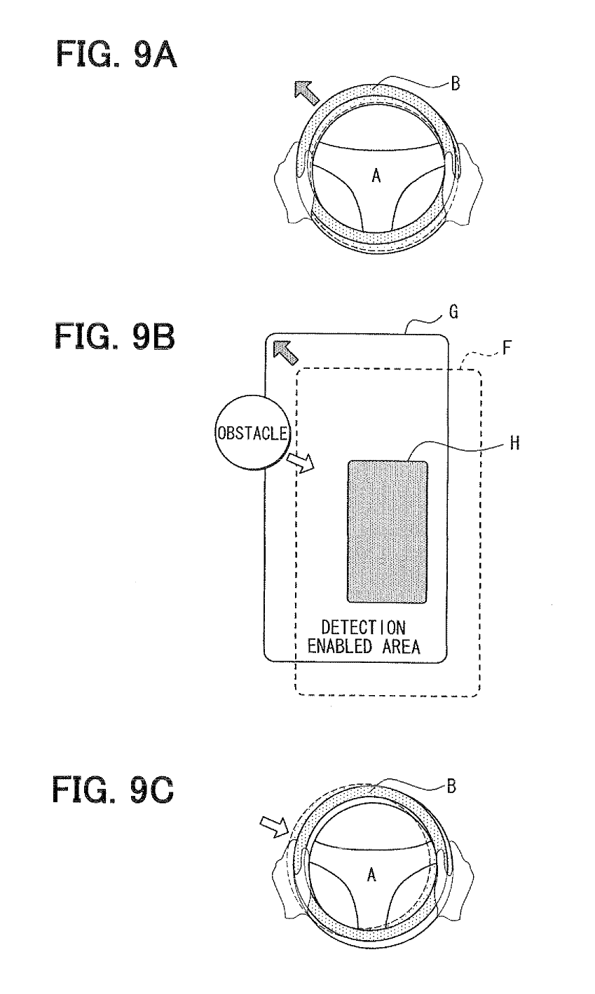

With reference to FIGS. 9A to 9C, examples of the operation of the obstacle search system 100 are described. FIGS. 9A to 9C show the operation of the obstacle search system 100 only schematically. In addition, the occupant operating the HMI device 4 is assumed to be a driver of the own vehicle, and the HMI device 4 is assumed to be a linear slider as shown in FIG. 3.

Assuming first that the driver of the own vehicle wanted to determine a position of the obstacle, that is, the direction and distance of the obstacle. In this case, the driver displaces the movable part B of the HMI device 4 by a desired amount to a desired direction as shown in FIG. 9A. The broken line in FIG. 9A shows a position of the movable part B before displacement, and a black arrow shows the direction of displacement of the movable part B.

When the driver displaces the movable part B in a left upward direction, the displacement of the movable part B (i.e., a displacement direction and an amount of displacement) is detected by the displacement sensor 42. Then, according to the displacement direction and the amount of displacement, the sensing range control unit 5 moves the detection enabled area of the obstacle detection sensor 1 toward the diagonally front left of the own vehicle as shown in FIG. 9B. In FIG. 9B, a broken line F shows a before-movement detection enabled area, and a solid line G shows an after-movement detection enabled area, together with a solid black area H of the own vehicle. Further, a solid black arrow shows a movement direction of the detection enabled area, and, a hollow white arrow shows a direction in which the obstacle “engages” the after-movement detection enabled area.

When the obstacle of the diagonally front left direction of the own vehicle is included in the after-movement detection enabled area, a direction and a distance of the obstacle are identified by the obstacle detection sensor 1 and the obstacle position calculation unit 2. Then, according to the identified direction and distance, the haptic presentation unit 43 moves the movable part B in a sliding manner under control of the presentation control unit 3 as shown in FIG. 9C, so that the movable part B generates a resistance force from the diagonally upper left direction by the amount according to the identified distance of the obstacle. In FIG. 9C, a broken line C shows a position of the movable part B before sliding, and a hollow white arrow shows a resistance force application direction.

As described above, the obstacle search system 100 generates and applies a resistance force to the movable part B of the operation unit 41 which is operated by the driver for a direction input operation, and the direction and amount of the resistance force is determined according to the direction and distance of the obstacle. Then, the driver of the vehicle receives practical presentation of the position of the obstacle through haptic sensation caused by the mechanical stimulation from the resistance force.

Based on the above configuration, the driver of the own vehicle inputs a direction input for moving the detection enabled area by operating the movable part B, and displacement of the part B is detected by the sensor to be used as a direction of the movement, the detection enabled area is moved to a user-desired direction to detect the obstacle. Therefore, the driver of the own vehicle can actively search the obstacle around the own vehicle, and the driver of the own vehicle can get a sense of distance based on the result of the obstacle search.

In addition, the information of the distance and direction of the obstacle is provided from the haptic presentation unit 43 to the occupant of the own vehicle through haptic sensation based on the above configuration, the driver of the own vehicle is enabled to recognize a sense of distance between the own vehicle and the obstacle in more details, even when the driver is seeing the obstacle with his/her eyes and by using mirrors. That is, in other words, the driver is assisted to have a secure sense of distance and direction of the obstacle while he/she confirms the obstacle with the eyes and mirrors.

Further, based on the above configuration, the haptic presentation unit 43 controls the operation unit 41 to generate the resistance force (i.e., the reactive operation force) while the operation unit 41 accepts the direction input operation, for the purpose of presenting the direction and distance of the obstacle, the driver of the own vehicle is enabled to check the direction and distance of the obstacle while the moving the detection enabled area according to the direction input operation of the operation unit 41, by sensing and feeling the reactive operation force from the operation unit 41. Therefore, the driver of the own vehicle, or the occupant of the own vehicle, is supported and enabled to accurately grasping and establishing a sense of vehicle size of the own vehicle, by repeating a series of a detection enabled area movement step and a detected information grasping step, based on the sense of distance from those steps. As a result, the occupant of the own vehicle can acrurately recognize the relationship between the own vehicle and the obstacle with confidence.

Further, based on the above configuration, the occupant of the own vehicle can exclude an “unnecessary” obstacle, which has been noticed and is not required to be detected, from the detection enabled area by moving it. Therefore, unnecessary detection of an obstacle is reduced.

Furthermore, because both of the operation unit 41 and the haptic presentation unit 43 are installed on the equipment of the own vehicle, which is operated by the hand of the occupant, and both of the operation unit 41 and the haptic presentation unit 43 are configured to be operable while the occupant is touching and/or operating the equipment, the occupant of the own vehicle can move the detection enabled area and can receive position information of the obstacle calculated by the calculation unit 2 while operating the equipment. Therefore, the occupant of the own vehicle can have an improved convenience for the driving operation. Further, while the occupant is operating the equipment of the own vehicle, the input from the operation unit 41 may be considered as “a disturbed condition,” and may not be used to move the detection enabled area. That is, the displacement of the operation unit may not be detected by the displacement detector as the direction input operation accepted by the operation unit if the operation unit is determined to be in “a disturbed condition,” and the operation unit is determined to be in the disturbed condition during an operation of a steering wheel of the vehicle if the operation unit is disposed on the steering wheel,

In the above-mentioned embodiment, the obstacle position calculation unit 2 and the sensing range control unit 5 are separately disposed. However, those components may be formed in one body as an ECU.

In addition, the operation unit 41 and the haptic presentation unit 43 formed in one body in the above embodiment may be disposed separately at two different positions.

Further, while the direction and distance of the obstacle is provided as information from the haptic presentation unit 43 to the occupant through haptis sensation in the above embodiment, the information of the direction and distance of the obstacle may be provided from a speaker as voice output, or may be provided from a display unit as an image.

Further, an obstacle search system for use in a vehicle may include: an operation device having an operation unit for accepting a direction input operation from an occupant of the vehicle and a displacement detector for detecting displacement of the operation unit by the direction input operation, wherein the operation unit is disposed to be displaceable along at least one of two axes, a first axis corresponding to a front-rear direction of the vehicle and a second axis corresponding to a right-left direction of the vehicle; together with an obstacle detector for detecting a position of an obstacle in a measurement range, wherein the obstacle detector includes a measurement range move section for moving the measurement range of the obstacle detector; an information presenter for presenting information of the position of the detected obstacle; and a measurement range controller for controlling the measurement range move section to move the measurement range according to the displacement detected by the displacement detector. In addition, the operation unit of the obstacle search system is disposed in association with a steering wheel which is disposed to be rotatable in a plane that includes the first and second axes for controlling a travel direction of the vehicle, and parallel displacement of the operation unit is allowed in a direction that is different from a rotation direction of the steering wheel.

The above described structure and configuration of the operation unit on the streering wheel is advantageous because the operation of the steering wheel and the operation of the operation unit have respectively different operation directions, thereby distinguishable from each other.

Although the present disclosure has been fully described in connection with preferred embodiment thereof with reference to the accompanying drawings, it is to be noted that various changes and modifications will become apparent to those skilled in the art.

Such changes, modifications, and summarized schemes are to be understood as being within the scope of the present disclosure as defined by appended claims.

What is claimed is:

1. An obstacle search system for use in a vehicle comprising:
an obstacle detector for detecting a position of an obstacle in a measurement range, wherein the obstacle detector includes a measurement range move section for moving the measurement range of the obstacle detector;
an information presenter for presenting information of the position of the detected obstacle;
an operation device having an operation unit for accepting a direction input operation from an occupant of the vehicle and a displacement detector for detecting displacement of the operation unit by the direction input operation; and
a measurement range controller for controlling the measurement range move section to move the measurement range according to the displacement detected by the displacement detector,

2. The obstacle search system of claim 1, wherein
the obstacle detector identifies a direction and a distance of the obstacle relative to the vehicle as the position of the detected obstacle, and
the information presenter presents the information of the detected obstacle based on the direction and the distance of the detected obstacle.

3. The obstacle search system of claim 1, wherein
the information presenter presents the information of the position of the detected obstacle detected by the obstacle detector through haptic sensation of the occupant of the vehicle.

4. The obstacle search system of claim 3, wherein
the information presenter and the operation unit are disposed on a vehicle equipment that is operated by a hand of the occupant, and
the occupant is enabled to operate the operation unit while the occupant is operating the equipment.

5. The obstacle search system of claim 4, wherein
the obstacle detector identifies a direction and a distance of the detected obstacle relative to the vehicle as the position of the detected obstacle, and
the information presenter presents, as information of the detected obstacle, the direction and the distance of the detected obstacle by applying a reactive operation force to the operation unit based on the direction and the distance of the detected obstacle.

6. The obstacle search system of claim 5, wherein
the information presenter decreases an application cycle of the reactive operation force in proportion to closeness of the detected obstacle to the vehicle.

7. The obstacle search system of claim 5, wherein
the information presenter increases an amount of the reactive operation force in proportion to closeness of the detected obstacle to the vehicle.

8. The obstacle search system of claim 4, wherein
the information presenter and the operation unit are disposed on at least one of hand-operated vehicle equipments including a steering wheel, a steering switch, an operation device on a center console, and a shift knob.

9. The obstacle search system of claim 3, wherein
the information presenter presents the information of the position of the detected obstacle by providing mechanical stimulus to the occupant from an actuator that is capable of causing a physical displacement.

10. The obstacle search system of claim 1, wherein
the measurement range controller includes a vehicle-related information acquisition unit for acquiring vehicle-related information including at least one of driving information of the vehicle and surrounding environment information of the vehicle, and
an amount of the movement of the measurement range by the measurement range move section according to the displacement detected by the displacement detector is corrected based on the vehicle-related information from the vehicle-related information acquisition unit.

11. The obstacle search system of claim 1, wherein
the obstacle detector detects the obstacle in the measurement range by using one or more obstacle detection sensors.

12. The obstacle search system of claim 1, wherein
the operation unit is displaceable in all directions or in fixed directions within a predetermined displacement range on an operation plane that is defined by two mutually-orthogonal axes along a lateral and longitudinal directions of the vehicle, and
the displacement detector detects an amount and a direction of the displacement of the operation unit due to the direction input operation by using a displacement sensor.

13. The obstacle search system of claim 12, wherein
the operation unit is displaceable in all directions within the predetermined displacement range on the operation plane by utilizing a combination of two slide tables sliding along the lateral and longitudinal directions of the vehicle.

14. An obstacle search system for use in a vehicle comprising:
an obstacle detector for detecting a position of an obstacle in a measurement range, wherein the obstacle detector includes a measurement range move section for moving the measurement range of the obstacle detector;
an information presenter for presenting information of the position of the detected obstacle;
an operation device having an operation unit for accepting a direction input operation from an occupant of the vehicle and a displacement detector for detecting displacement of the operation unit by the direction input operation, wherein the operation unit is disposed to be displaceable along at least one of two axes, a first axis corresponding to a front-rear direction of the vehicle and a second axis corresponding to a right-left direction of the vehicle; and
a measurement range controller for controlling the measurement range move section to move the measurement range according to the displacement detected by the displacement detector.

15. The obstacle search system of claim 14, wherein
the operation unit is disposed in association with a steering wheel which is disposed to be rotatable in a plane that includes the first and second axes for controlling a travel direction of the vehicle, and
parallel displacement of the operation unit is allowed in a direction that is different from a rotation direction of the steering wheel.
